(19) United States
(12) Patent Application Publication
(10) Pub. No.: US 2026/0214591 A1
(43) Pub. Date: Jul. 23, 2026

(54) INTER-BAND POWER CORRELATION REPORT FOR CONTINUOUS UE UL POWER CONTROL

(71) Applicant: QUALCOMM Incorporated, San Diego, CA (US)

(72) Inventors: Idan Michael HORN, Hod Hasharon (IL); Yehonatan DALLAL, Kfar Saba (IL); Shay LANDIS, Hod Hasharon (IL)

(21) Appl. No.: 19/141,033

(22) PCT Filed: Feb. 5, 2024
(86) PCT No.: PCT/US2024/014427

§ 371 Date: Jun. 18, 2025

(30) Foreign Application Priority Data
Feb. 17, 2023 (IL) 300748

(51) Int. Cl. H04W 52/14

(52) U.S. Cl. CPC H04W 52/146

(57) ABSTRACT

Apparatuses and methods for inter-band power correlation report for continuous UE UL power control are described. An apparatus is configured to measure at least one of: (1) correlation information associated with a correlation between a first power of a first frequency band and a second power of a second frequency band or (2) the first power of the first frequency band. The first frequency band and the second frequency band are associated with beam transmissions from a network node, and the first frequency band is associated with a higher periodicity than the second frequency band. The apparatus is also configured to update an uplink output power for the second frequency band based on at least one of: (1) the correlation between the first power of the first frequency band and the second power of the second frequency band or (2) the measured first power of the first frequency band.

### CROSS-REFERENCE TO RELATED APPLICATION

This application claims the benefit of Israel Patent Application Serial No. 300748, entitled “INTER-BAND POWER CORRELATION REPORT FOR CONTINUOUS UE UL POWER CONTROL” and filed on Feb. 17, 2023, which is expressly incorporated by reference herein in its entirety.

### TECHNICAL FIELD

The present disclosure relates generally to communication systems, and more particularly, to wireless communications systems and user equipment (UE) power control.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is configured to measure at least one of: (1) correlation information associated with a correlation between a first power of a first frequency band and a second power of a second frequency band or (2) the first power of the first frequency band, where the first frequency band and the second frequency band are associated with beam transmissions from a network node, and the first frequency band is associated with a higher periodicity than the second frequency band, and where the apparatus is also configured to update an uplink output power for the second frequency band based on at least one of: (1) the correlation between the first power of the first frequency band and the second power of the second frequency band or (2) the measured first power of the first frequency band.

In the aspect, the method includes measuring at least one of: (1) correlation information associated with a correlation between a first power of a first frequency band and a second power of a second frequency band or (2) the first power of the first frequency band, where the first frequency band and the second frequency band are associated with beam transmissions from a network node, where the first frequency band is associated with a higher periodicity than the second frequency band. The method also includes updating an uplink output power for the second frequency band based on at least one of: (1) the correlation between the first power of the first frequency band and the second power of the second frequency band or (2) the measured first power of the first frequency band.

In another aspect of the disclosure, a method, a computer-readable medium, and an apparatus are provided. The apparatus is configured to receive, from a user equipment (UE), a measurement for at least one of (1) correlation information associated with a correlation between a first power of a first frequency band and a second power of a second frequency band or (2) a power of the first frequency band, where the first frequency band and the second frequency band are associated with beam transmissions from the network node, where the first frequency band is associated with a higher periodicity than the second frequency band, where at least one of the measured correlation information or the measured first power of the first frequency band are for an update of an uplink output power for the second frequency band. The apparatus is also configured to transmit, to the UE, a configuration associated with the uplink output power for the second frequency band based on at least one of: (1) the correlation between the first power of the first frequency band and the second power of the second frequency band or (2) the measured first power of the first frequency band.

In the other aspect, the method includes receiving, from a user equipment (UE), a measurement for at least one of (1) correlation information associated with a correlation between a first power of a first frequency band and a second power of a second frequency band or (2) a power of the first frequency band, where the first frequency band and the second frequency band are associated with beam transmissions from the network node, where the first frequency band is associated with a higher periodicity than the second frequency band, where at least one of the measured correlation information or the measured first power of the first frequency band are for an update of an uplink output power for the second frequency band. The method also includes transmitting, to the UE, a configuration associated with the uplink output power for the second frequency band based on at least one of: (1) the correlation between the first power of the first frequency band and the second power of the second frequency band or (2) the measured first power of the first frequency band.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example configuration for UE UL signaling, in accordance with various aspects of the present disclosure.

FIG. 5 is a call flow diagram for wireless communications, in accordance with various aspects of the present disclosure.

FIG. 6 is a diagram illustrating an example configuration for UE UL signaling power control, in accordance with various aspects of the present disclosure.

FIG. 7 is a flowchart of a method of wireless communication, in accordance with various aspects of the present disclosure.

FIG. 8 is a flowchart of a method of wireless communication, in accordance with various aspects of the present disclosure.

FIG. 9 is a flowchart of a method of wireless communication, in accordance with various aspects of the present disclosure.

FIG. 10 is a flowchart of a method of wireless communication, in accordance with various aspects of the present disclosure.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

Wireless communication networks, such as an LTE network and/or a 5G NR network, may be designed for UE and base station power efficiency. Future wireless communication networks beyond 5G NR, such as 5G+ and 6G, may increase the use of additional frequencies for communications and additional types of communications, which have corresponding impacts on power consumption for UEs and/or base stations. That is, increased communications and higher-power consumption for additional supported communication frequencies may increase power consumption for devices associated with a wireless communication network.

As one example, a power amplifier (PA) used for UL transmissions in a wireless communication network may have a dominant part in overall modem power consumption, which may be exacerbated in new/additional frequency bands with higher carrier frequencies that may decrease the PA output power and reduce the power-added efficiency (PAE). Determining an optimal PA output power for power efficiency (e.g., bits per Joule) may be complex and difficult, and may involve a continuous tracking of the channel(s) and/or blockers, which may involve additional power consumption. Further, this continuous tracking may not be feasible in all bands as some of the bands may have a high multi-user occupancy (e.g., in frequency range designation FR1 (410 MHz-7.125 GHz) bands).

Various aspects relate generally to wireless communications systems and user equipment power control. Some aspects more specifically relate to reporting inter-band power correlation(s) for continuous UE UL power control. In some examples, a continuous UL power procedure is provided according to a report of new power correlation band information. For instance, a UE may change its UL output power in a first band according to the power measurements in second band, where this second band may have a high power correlation with the first band, e.g., as measured by the UE, and may also be more available/accessible for the power measurements.

Particular aspects of the subject matter described in this disclosure can be implemented to realize one or more of the following potential advantages. In some examples, by utilizing the power correlation between frequencies, the described techniques can be used to maintain continuous UL power control for efficient UE power control that obviates monitoring power for each controlled frequency. That is, in aspects, unoccupied frequency bands may be utilized for power measurements which may then be used to extrapolate/determine power measurements for occupied frequency bands. This reduces power consumption by determining power measurements for frequencies without direct measurements and makes network-associated devices more power efficient.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manuifacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

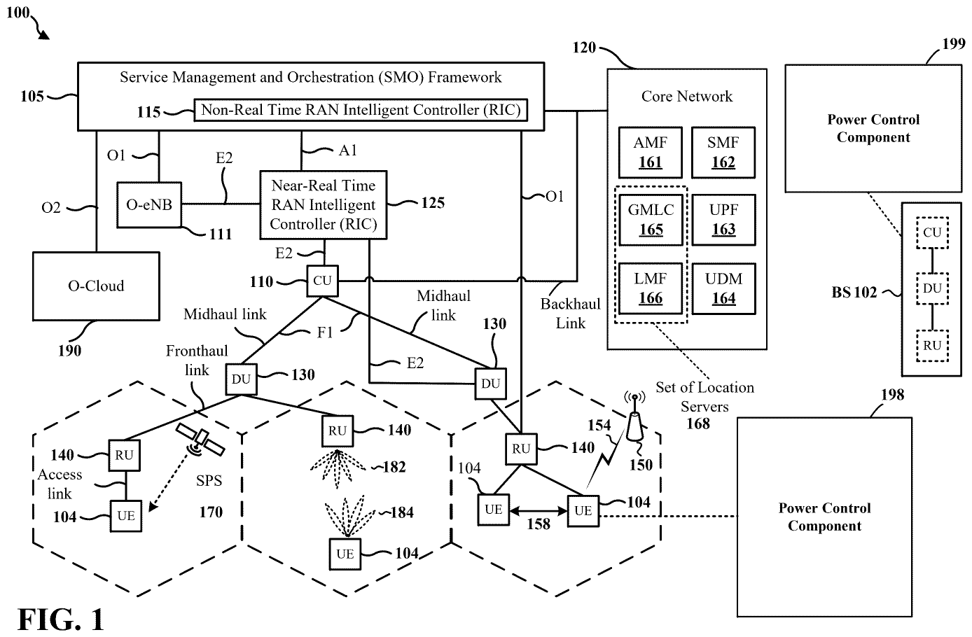

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a power control component 198 (“component 198”) that may be configured to measure at least one of: (1) correlation information associated with a correlation between a first power of a first frequency band and a second power of a second frequency band or (2) the first power of the first frequency band, where the first frequency band and the second frequency band are associated with beam transmissions from a network node, where the first frequency band is associated with a higher periodicity than the second frequency band. The component 198 may be further configured to update an uplink output power for the second frequency band based on at least one of: (1) the correlation between the first power of the first frequency band and the second power of the second frequency band or (2) the measured first power of the first frequency band. The component 198 may be configured to provide, for the network node, at least one of the measured correlation information or the measured first power of the first frequency band for an update of the uplink output power for the second frequency band, and to receive, from the network node, a configuration associated with the uplink output power for the second frequency band based on at least one of the measured correlation information or the measured first power of the first frequency band. The component 198 may be configured to provide, for the network node, inter-band uplink control information of the UE, where the inter-band uplink control information includes at least one of a capability of the UE to monitor the first power of the first frequency band, a correlation threshold value between the first power of the first frequency band and the second power of the second frequency band, or a set of supported frequency bands associated with measuring the correlation information. The component 198 may be configured to receive, from the network node, the first frequency band associated with the beam transmissions, and to transmit, for the network node, the first frequency band associated with the beam transmissions. The component 198 may be configured to provide, for the network node and via the first frequency band, the first power of the first frequency band. The component 198 may be configured to receive, from the network node, correlation threshold information associated with the correlation between the first power of the first frequency band and the second power of the second frequency band, and to continue or discontinue to monitor the first power of the first frequency band based on the correlation threshold information. In certain aspects, the base station 102 may have a power control component 199 (“component 199”) that may be configured to receive, from a user equipment (UE), a measurement for at least one of (1) correlation information associated with a correlation between a first power of a first frequency band and a second power of a second frequency band or (2) a power of the first frequency band, where the first frequency band and the second frequency band are associated with beam transmissions from the network node, where the first frequency band is associated with a higher periodicity than the second frequency band, where at least one of the measured correlation information or the measured first power of the first frequency band are for an update of an uplink output power for the second frequency band. The component 199 may be further configured to transmit, to the UE, a configuration associated with the uplink output power for the second frequency band based on at least one of: (1) the correlation between the first power of the first frequency band and the second power of the second frequency band or (2) the measured first power of the first frequency band. The component 199 may be configured to generate the configuration associated with the uplink output power for the second frequency band for the update to the uplink output power. The component 199 may be configured to receive, from the UE, inter-band uplink control information of the UE, where the inter-band uplink control information includes at least one of a capability of the UE to monitor the first power of the first frequency band, a correlation threshold value between the first power of the first frequency band and the second power of the second frequency band, or a set of supported frequency bands associated with measuring the correlation information. The component 199 may be configured to transmit, for the UE, the first frequency band associated with the beam transmissions, and to receive, from the UE, the first frequency band associated with the beam transmissions. The component 199 may be configured to receive, from the UE and via the first frequency band, the first power of the first frequency band. The component 199 may be configured to transmit, for the UE, correlation threshold information associated with the correlation between the first power of the first frequency band and the second power of the second frequency band, where the correlation threshold information configures the UE to continue or discontinue to monitor the first power of the first frequency band based on the correlation threshold information. That is, aspects provide inter-band power correlation reporting for continuous UE UL power control that enables a UE to utilize power correlations for frequency bands to determine the power of other frequency bands without direct power measurements thereof, which reduces power consumption.

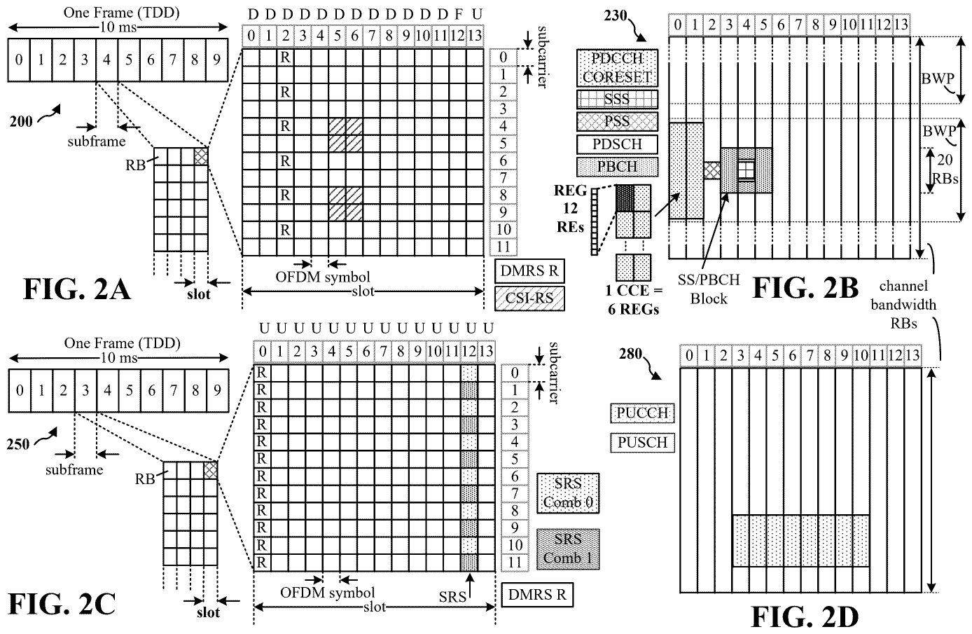

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} • 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

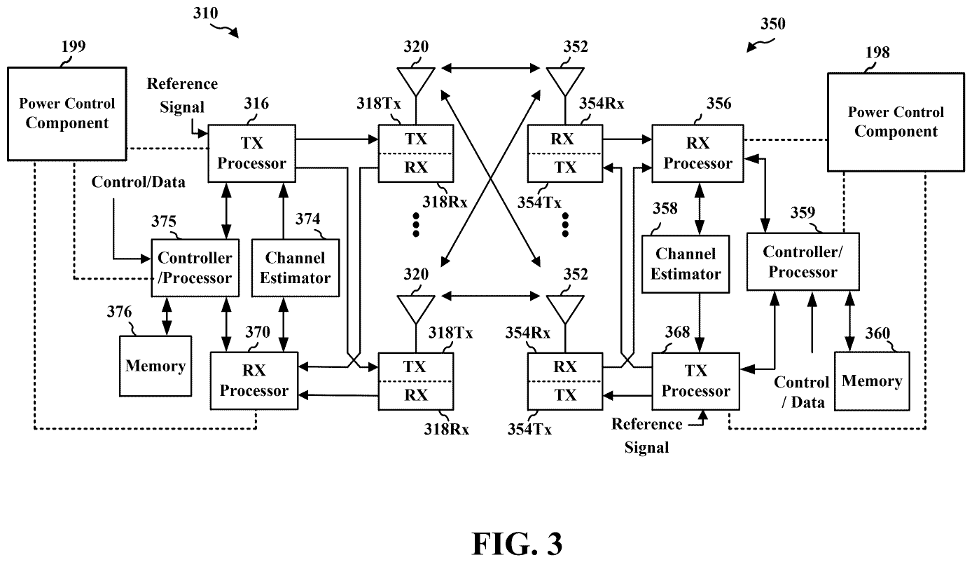

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the power control component 198 of FIG. 1. At least one of the TX processor 316, the RX processor 370, and the controller/processor 375 may be configured to perform aspects in connection with the power control component 199 of FIG. 1.

Wireless communication networks, such as an LTE network and/or a 5G NR network, may be designed for UE and base station power efficiency. Future wireless communication networks beyond 5G NR, such as 5G+ and 6G, may increase the use of additional frequencies for communications and additional types of communications, which have corresponding impacts on power consumption for UEs and/or base stations. That is, increased communications and higher-power consumption for additional supported communication frequencies may increase power consumption for devices associated with a wireless communication network. A PA used for UL transmissions in a wireless communication network may have a dominant part in overall modem power consumption, which may be exacerbated in new/additional frequency bands with higher carrier frequencies that may decrease the PA output power and reduce the PAE. As described herein, a frequency band may be a set or subset of frequencies that make up a frequency range (FR), in whole or in part, such as FR1, FR2, etc. Determining an optimal PA output power for power efficiency may be complex and difficult, and may involve a continuous tracking of the channel(s) and/or blockers, which may involve additional power consumption. Further, this continuous tracking may not be feasible in all bands as some of the frequency bands may have a high multi-user occupancy (e.g., in FR1 bands).

The aspects herein enable a device of a wireless communication network to obtain the power tracking for a higher frequency band (and aspects also contemplate application via low bandwidth/low power modulation) and update a lower band UL power control based on the power in the higher band (e.g., via power and/or correlation measurements). In aspects, the UE provides a new report and/or information for inter-band power correlation which may specify the correlation of the signal power between the different bands at issue. As one example, the UE may report/provide to a base station a power correlation of 0.99 between FR2 and FR5, and thus, if the power in FR2 droops 10 dB, by way of example, the base station and/or the UE may extrapolate the energy difference in FR5 as also being ~10 dB for its UL power control based on the power correlation. In some aspects, a threshold value may be satisfied to implement such power correlation.

Accordingly, aspects introduce a new report/provision of information for power correlation between frequency bands and a corresponding continuous UL power procedure in configurations for which the power correlation value is bigger than a certain threshold. For instance, the aspects described provide for reporting inter-band power correlation(s) for continuous UE UL power control, including measuring power correlation (e.g., linear or non-linear) between first and second frequency bands and/or measuring a power of the first frequency band, and updating an UL output power for the second frequency band based on the measurement(s). In aspects, the first and second frequency bands may be associated with beam transmissions (e.g., continuous beam transmissions from a base station), and the first frequency band may have a higher periodicity than the second frequency band. Utilizing the power correlation between frequencies, the described aspects may maintain continuous UL power control for efficient UE power control without monitoring power for each controlled frequency. In other words, power of unoccupied frequency bands may be measured may then be used to extrapolate/determine power measurements for occupied frequency bands without direct power measurements, and such aspects may thus reduce power consumption making the UE more power efficient.

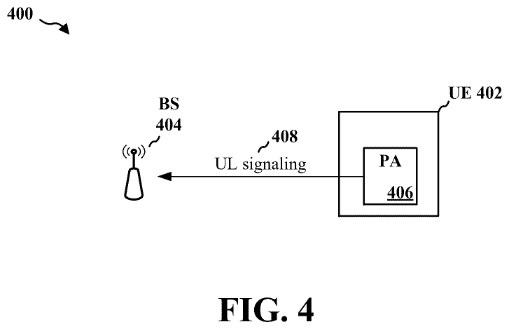

FIG. 4 is a diagram 400 illustrating an example configuration for UE UL signaling, in various aspects. Diagram 400 shows a UE 402 and a base station 404 (e.g., a network node). The UE 402 provides UL signaling 408 to the base station 404 via a PA 406. As noted above, the PA 406, in providing UL signaling 408 to the base station 404, may have a dominant part in overall modem power consumption, and the current signaling/frequency use in wireless communication networks, as well as the advent of additional signaling/frequencies in new generation wireless communication networks, may increase the power consumption of devices to achieve UL power control. For instance, a continuous tracking of channels and/or blockers may be utilized for each controlled UL power instance, which may involve additional power consumption.

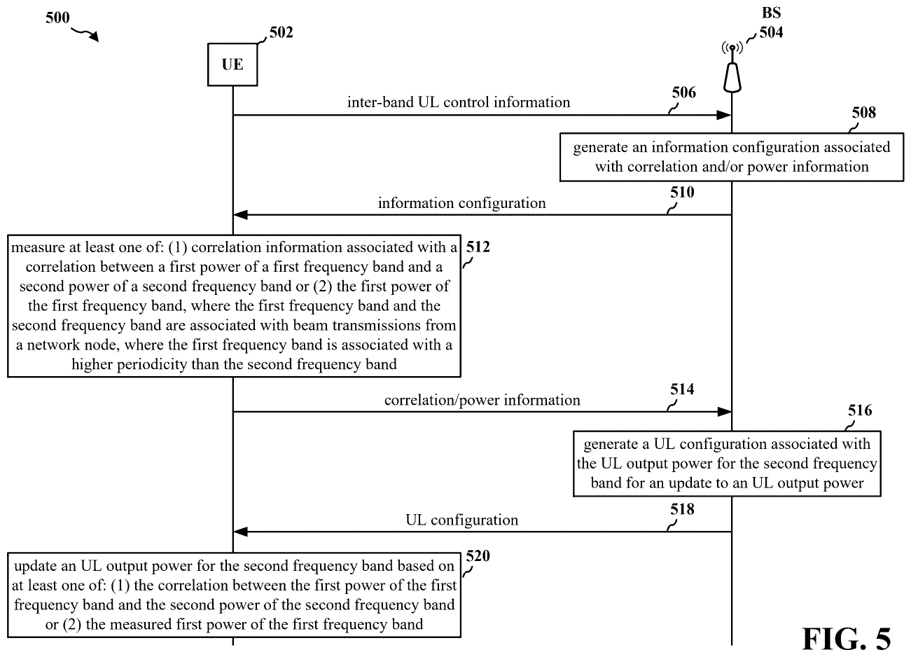

FIG. 5 is a call flow diagram 500 for wireless communications, in various aspects. Call flow diagram 500 illustrates reporting inter-band power correlation(s) for continuous UL power control in wireless communications for a UE (e.g., a UE 502) with a network node (a base station 504, such as a gNB or other type of base station, by way of example, as shown). Aspects described for the base station 504 may be performed by the base station in aggregated form and/or by one or more components of the base station 504 in disaggregated form. Additionally, or alternatively, the aspects may be performed by the UE 502 autonomously, in addition to, and/or in lieu of, operations of the base station 504.

In the illustrated aspect, the UE 502 may be configured to provide/transmit UL control information 506, which may be inter-band, to the base station 504. In aspects, the UL control information 506 may generally be parameters, UE capability information, and/or other information associated with UL power control, and may include, without limitation, a capability of the UE 502 to monitor the first power of the first frequency band, a correlation threshold value between the first power of the first frequency band and the second power of a second frequency band, a set of supported frequency bands associated with measuring the correlation information (e.g., information related to power and/or correlations between the first and second frequency bands), an indication of hardware at the UE for transmitting the first frequency band associated with the beam transmissions, a loss parameter of the hardware, a change in the loss parameter of the hardware, and/or the like. Based at least in part on the received UL control information 506, the base station 504 may be configured at 508 to generate an information configuration 510 associated with correlation and/or power information. The base station 504 may be configured to provide the information configuration 510 for reception by the UE 502. In aspects, the first frequency band may be similar or identical to the second frequency band, while in other aspects, the first frequency band may be dissimilar or different from the second frequency band.

In aspects, the UE 502 may be configured to receive, from the base station 504, the first frequency band associated with the beam transmissions, which may be a continuous beam transmission. In aspects for which the base station 504 may be aware of measurements at the UE 502, described herein, the UE 502 may be configured to transmit, for the base station 504, the first frequency band associated with the beam transmissions (e.g., reflecting the first frequency beam back to the base station 504. Such transmitting or reflecting may be performed by the UE 502 when configured with a reconfigurable intelligent surface (RIS), a modulating retro-reflector (MRR), etc.

Based at least in part on the information configuration 510, the UE 502 may be configured at 512 to measure at least one of: (1) correlation information associated with a correlation between a first power of a first frequency band and a second power of a second frequency band or (2) the first power of the first frequency band, where the first frequency band and the second frequency band are associated with beam transmissions from the base station 504 (e.g., a network node), where the first frequency band may be associated with a higher periodicity than the second frequency band. For example, the higher periodicity may be associated with data periodicity, a SSB, a slot periodicity, a continues signal, and/or the like for the first frequency band. The UE 502 may then be configured to transmit or provide, for the base station 504, information 514 that may be associated with correlation and/or power information. For instance, the information 514 may include the measured correlation information and/or the measured first power of the first frequency band for an update of the uplink output power (e.g., an amount of power utilized by a UE for UL signaling for a given frequency band) for the second frequency band, including but not limited to, measured correlation information such as a network correlation value associated with a first correlation information parameter of the base station 504 or a maximal correlation value associated with a second correlation information parameter of the UE 502, where the second correlation information parameter of the UE 502 may be different from the first correlation information parameter of the base station 504, and where the maximal correlation value may be greater than the network correlation value. In aspects, a correlation information parameter may be utilized to calculate a power correlation between frequency bands, e.g., a metric that may be linear or non-linear for determining a correlating relationship, such as a ratio or percentage (“½” by way of example, which is linear) or an exponential relation (“to the power of 2” or (“×²”), which is non-linear). In some aspects, the UE 502 may be configured to provide, for the base station 504 and via the first frequency band, the first power of the first frequency band for the information 514.

The base station 504, at 516, may be configured to generate a UL configuration 518 associated with the UL output power for the second frequency band for an update to an UL output power. The UL configuration 518 may be based on and/or associated with the UL output power for the second frequency band based the information 514, e.g., based on at least one of the measured correlation information, the measured first power of the first frequency band, and/or the like. The base station 504 may thus be configured to configure the UE with the UL configuration 518 that is associated with the uplink output power for the second frequency band based on at least one of: (1) the correlation between the first power of the first frequency band and the second power of the second frequency band or (2) the measured first power of the first frequency band. In aspects, to generate at 516 the UL configuration 518 as associated with the uplink output power for the second frequency band for the update to the uplink output power.

The base station 504 may be configured to provide or transmit, for reception by the UE 502, the UL configuration 518, and the UE 502 may be configured, at 520 and via the UL configuration 518, to update an UL output power for the second frequency band based on at least one of: (1) the correlation between the first power of the first frequency band and the second power of the second frequency band or (2) the measured first power of the first frequency band. In some aspects, the UE 502 may be configured to update the uplink output power for the second frequency band based on the correlation between the first power of the first frequency band and the second power of the second frequency band being greater than a power threshold.

That is, the UE 502 may be configured, at 520 and via the UL configuration 518, to update an UL output power for the second frequency band without making direct power measurements therefor, thus improving power efficiency of at least the UE 502 and increasing the overall processing efficiency of the UE 502.

In one configuration, the UE 502 may be configured to receive, as provided from the base station 504, correlation threshold information associated with the correlation between the first power of the first frequency band and the second power of the second frequency band, based on this correlation threshold information, the UE 502 may be configured to continue or discontinue to monitor the first power of the first frequency band.

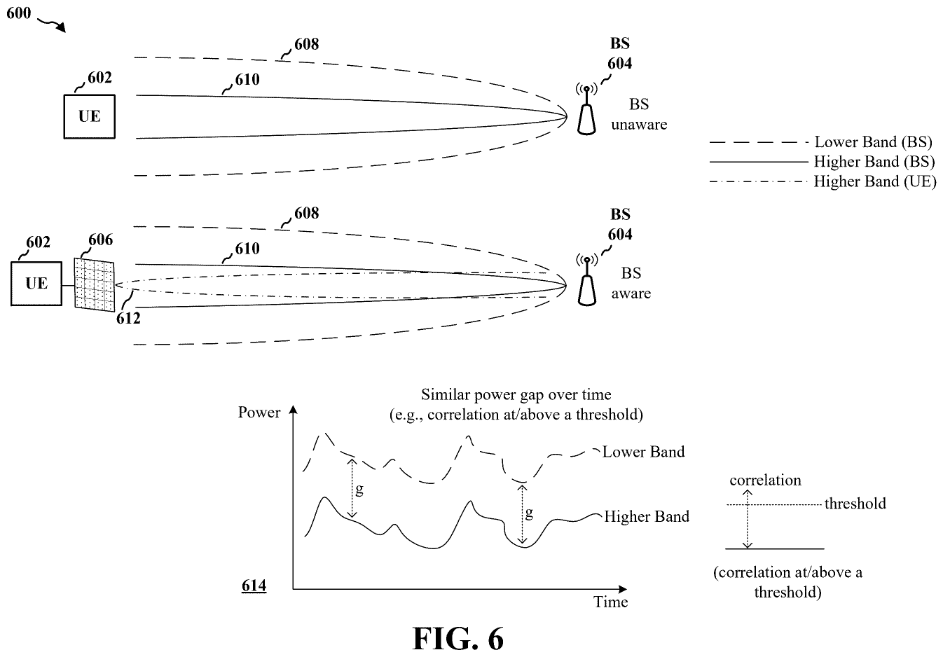

FIG. 6 is a diagram 600 illustrating example configurations for UE UL signaling power control, in various aspects. Diagram 600 shows an unaware configuration and an aware configuration between a UE 602 and a base station 604 (e.g., a network node). That is, aspects herein may be applicable for cases in which a base station may be either unaware of, or aware of, the changes in the higher frequency band (e.g., the first frequency band).

In configurations without base station awareness, the UE 602 may receive from the base station 604 a continuous beam transmission on the higher/first frequency band 610 (e.g., the higher frequency band may be FR2 to FR5 or even up to optics wireless bands such as laser transmission) and may measure/calculate a power correlation over time (e.g., to collect statistics) with the lower/second frequency band 608 (e.g., according to the base station 604 configuration). The UE 602 may provide/report information regarding the power correlation between a first power of the higher/first frequency band 610 and the second power of the lower/second frequency band 608, and the base station 604 may configure the UE 602 to work with continuous UL power control on the higher/first frequency band 610 and the second power of the lower/second frequency band 608. The UE 602 may thus be configured to update its UL output power in the lower/second frequency band 608 according to the power calculated in the higher/first frequency band 610 and/or the power correlation, without directly measuring the second power of the lower/second frequency band 608.

In configurations with base station awareness, the UE 602 may receive from the base station 604 a continuous beam transmission on the higher/first frequency band 610 and may provide/transmit back the higher/first frequency band 610 beam transmission for the base station 604 as a first frequency band 612 in order to calculate the power difference as well. The higher/first frequency band 610 beam transmission may be provided/transmitted back to the base station 604 by the UE 602 as the first frequency band 612 via a reflector 606 thereof, in some aspects (e.g., may be based on a RIS, a MRR, etc.). Both the UE 602 and the base station 604 may thus be aware of any change in the higher/first frequency band 610/612 that corresponds to a change for the second power of the lower/second frequency band 608, without directly measuring the second power of the lower/second frequency band 608 at the UE 602, and the base station 604 may have more awareness of the UE 602 lower/second frequency band 608 UL power procedure (e.g., the base station 604 may predict the UE 602 UL output power as it measures the same power over the same time).

As noted herein, the aspects for reporting inter-band power correlation(s) for continuous UE UL power control may be applied based on a threshold being met for the power correlation(s) between frequency bands, e.g., the higher/first frequency band 610 and the lower/second frequency band 608, in FIG. 6). Diagram 600 also illustrates a plot 614, shown as power with respect to time, for an example linear power correlation between the higher/first frequency band 610 and the lower/second frequency band 608. That is, the higher/first frequency band 610 and the lower/second frequency band 608 have a similar power gap ‘g’ therebetween over time, and thus a high correlation. In aspects, a threshold may be utilized to determine if continuous UL power control will be implemented by the UE 602. Such a threshold(s) may be based on discrete increments of units, a ratio (e.g., linear and/or non-linear), a specified and/or specific value(s), a rate of change (e.g., over time and/or frequency), and/or the like.

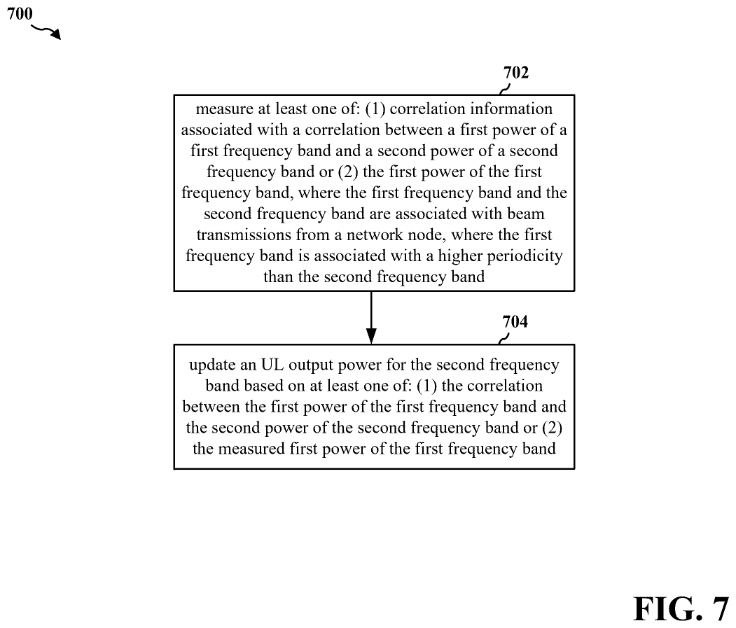

FIG. 7 is a flowchart 700 of a method of wireless communication, in various aspects. The method may be performed by a UE (e.g., the UE 104, 402, 502, 602). In some aspects, the method may include aspects described in connection with the communication flow in FIG. 5 and/or aspects described in FIG. 6. The method provides improvements in UE power utilization and control that enables a UE to utilize power correlations for frequency bands to determine the power of other frequency bands without direct power measurements thereof.

At 702, the UE measures at least one of: (1) correlation information associated with a correlation between a first power of a first frequency band and a second power of a second frequency band or (2) the first power of the first frequency band, where the first frequency band and the second frequency band are associated with beam transmissions from a network node, where the first frequency band is associated with a higher periodicity than the second frequency band. As an example, the measurement may be performed by one or more of the component 198. FIGS. 5, 6 illustrate an example of the UE 502 performing such measurement for a first frequency band transmission, which may be a continuous beam transmission, from a network node (e.g., the base station 504).

The UE 502 may be configured to provide/transmit UL control information 506, which may be inter-band, to the base station 504. In aspects, the UL control information 506 may include a capability of the UE 502 to monitor the first power of the first frequency band (e.g., 610 in FIG. 6), a correlation threshold value (e.g., 614 in FIG. 6) between the first power of the first frequency band (e.g., 610 in FIG. 6) and the second power of a second frequency band (e.g., 608 in FIG. 6), a set of supported frequency bands associated with measuring the correlation information (e.g., 614 in FIG. 6), an indication of hardware at the UE for transmitting the first frequency band (e.g., 610 in FIG. 6) associated with the beam transmissions, a loss parameter of the hardware, a change in the loss parameter of the hardware, and/or the like. Based at least in part on the received UL control information 506, the base station 504 may be configured at 508 to generate an information configuration 510 associated with correlation and/or power information (e.g., 614 in FIG. 6). The base station 504 may be configured to provide the information configuration 510 for reception by the UE 502. In aspects, the first frequency band (e.g., 610 in FIG. 6) may be similar or identical to the second frequency band (e.g., 608 in FIG. 6), while in other aspects, the first frequency band (e.g., 610 in FIG. 6) may be dissimilar or different from the second frequency band (e.g., 608 in FIG. 6).

In aspects, the UE 502 may be configured to receive, from the base station 504, the first frequency band (e.g., 610 in FIG. 6) associated with the beam transmissions, which may be a continuous beam transmission. In aspects for which the base station 504 may be aware of measurements at the UE 502, described herein, the UE 502 may be configured to transmit, for the base station 504, the first frequency band (e.g., 610 as 612 in FIG. 6) associated with the beam transmissions, e.g., reflecting the first frequency beam back to the base station 504. Such transmitting or reflecting may be performed by the UE 502 via a reflector (e.g., 606 in FIG. 6), e.g., when configured with a reconfigurable intelligent surface (RIS), a modulating retro-reflector (MRR), etc.

Based at least in part on the information configuration 510, the UE 502 may be configured at 512 to measure at least one of: (1) correlation information associated with a correlation (e.g., 614 in FIG. 6) between a first power of a first frequency band (e.g., 610 in FIG. 6) and a second power of a second frequency band (e.g., 608 in FIG. 6) or (2) the first power of the first frequency band (e.g., 610 in FIG. 6), where the first frequency band (e.g., 610 in FIG. 6) and the second frequency band (e.g., 608 in FIG. 6) are associated with beam transmissions from the base station 504 (e.g., a network node), where the first frequency band (e.g., 610 in FIG. 6) may be associated with a higher periodicity than the second frequency band (e.g., 608 in FIG. 6). For example, the higher periodicity may be associated with data periodicity, a SSB, a slot periodicity, a continues signal, and/or the like for the first frequency band. The UE 502 may then be configured to transmit or provide, for the base station 504, the information 514 that may be associated with correlation and/or power information (e.g., 614 in FIG. 6).

At 704, the UE updates an UL output power for the second frequency band based on at least one of: (1) the correlation between the first power of the first frequency band and the second power of the second frequency band or (2) the measured first power of the first frequency band. As an example, the update may be performed by one or more of the component 198. FIGS. 5, 6 illustrate an example of the UE 502 performing such an update for UL output power of the second frequency band (e.g., 610 in FIG. 6).

For instance, the UE 502 may be configured to transmit or provide, for the base station 504, the information 514 that may be associated with correlation and/or power information (e.g., 614 in FIG. 6), as noted above. The information 514 (e.g., 614 in FIG. 6) may include the measured correlation information and/or the measured first power of the first frequency band (e.g., 610 in FIG. 6) for an update of the uplink output power for the second frequency band (e.g., 608 in FIG. 6), including but not limited to, measured correlation information such as a network correlation value associated with a first correlation information parameter of the base station 504 or a maximal correlation value associated with a second correlation information parameter of the UE 502, where the second correlation information parameter of the UE 502 may be different from the first correlation information parameter of the base station 504, and where the maximal correlation value may be greater than the network correlation value. In some aspects, the UE 502 may be configured to provide, for the base station 504 and via the first frequency band (e.g., 610 in FIG. 6), the first power of the first frequency band (e.g., 610 in FIG. 6) for the information 514.

The base station 504, at 516, may be configured to generate a UL configuration 518 associated with the UL output power for the second frequency band (e.g., 608 in FIG. 6) for an update to an UL output power. The UL configuration 518 may be based on and/or associated with the UL output power for the second frequency band (e.g., 608 in FIG. 6) based the information 514 (e.g., 614 in FIG. 6), e.g., based on at least one of the measured correlation information, the measured first power of the first frequency band (e.g., 610 in FIG. 6), and/or the like. The base station 504 may thus be configured to configure the UE with the UL configuration 518 that is associated with the uplink output power for the second frequency band (e.g., 608 in FIG. 6) based on at least one of: (1) the correlation between the first power of the first frequency band (e.g., 610 in FIG. 6) and the second power of the second frequency band (e.g., 608 in FIG. 6) or (2) the measured first power of the first frequency band (e.g., 610 in FIG. 6). In aspects, to generate at 516 the UL configuration 518 as associated with the uplink output power for the second frequency band (e.g., 608 in FIG. 6) for the update to the uplink output power.

The base station 504 may be configured to provide or transmit, for reception by the UE 502, the UL configuration 518, and the UE 502 may be configured, at 520 and via the UL configuration 518, to update an UL output power for the second frequency band (e.g., 608 in FIG. 6) based on at least one of: (1) the correlation between the first power of the first frequency band (e.g., 610 in FIG. 6) and the second power of the second frequency band or (2) the measured first power of the first frequency band (e.g., 610 in FIG. 6). In some aspects, the UE 502 may be configured to update the uplink output power for the second frequency band (e.g., 608 in FIG. 6) based on the correlation (e.g., 614 in FIG. 6) between the first power of the first frequency band (e.g., 610 in FIG. 6) and the second power of the second frequency band (e.g., 608 in FIG. 6) being greater than a power threshold. That is, the UE 502 may be configured, at 520 and via the UL configuration 518, to update an UL output power for the second frequency band (e.g., 608 in FIG. 6) without making direct power measurements therefor, thus improving power efficiency of at least the UE 502 and increasing the overall processing efficiency of the UE 502. In one configuration, the UE 502 may be configured to receive, as provided from the base station 504, correlation threshold information (e.g., 614 in FIG. 6) associated with the correlation between the first power of the first frequency band (e.g., 610 in FIG. 6) and the second power of the second frequency band (e.g., 608 in FIG. 6), and based on this correlation threshold information (e.g., 614 in FIG. 6), the UE 502 may be configured to continue or discontinue to monitor the first power of the first frequency band (e.g., 610 in FIG. 6).

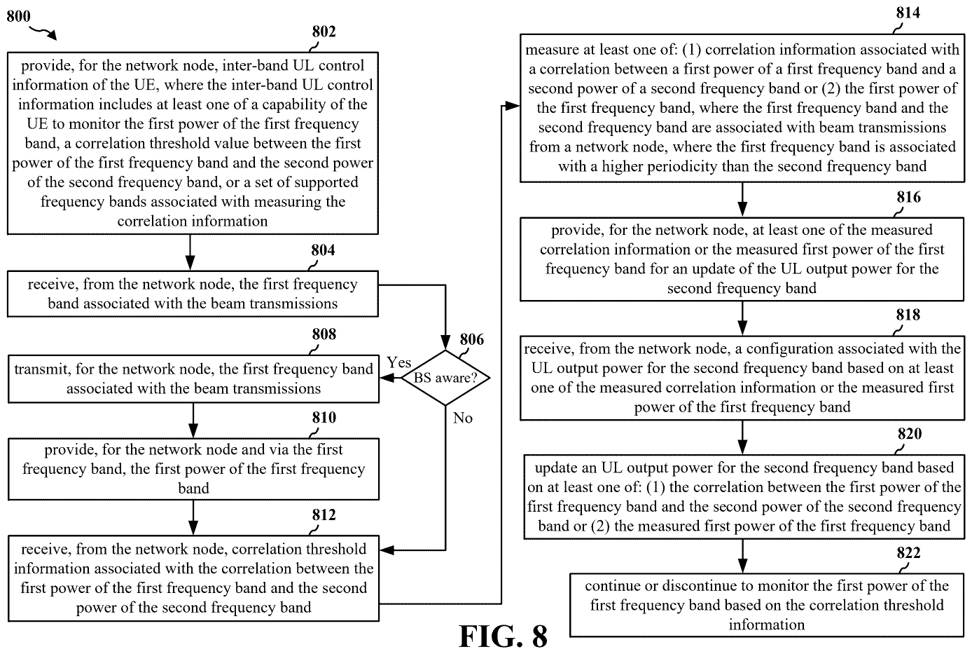

FIG. 8 is a flowchart 800 of a method of wireless communication, in various aspects. The method may be performed by a UE (e.g., the UE 104, 402, 502, 602). In some aspects, the method may include aspects described in connection with the communication flow in FIG. 5 and/or aspects described in FIG. 6. The method provides improvements in UE power utilization and control that enables a UE to utilize power correlations for frequency bands to determine the power of other frequency bands without direct power measurements thereof.

At 802, the UE provides, for the network node, inter-band UL control information of the UE, where the inter-band UL control information includes at least one of a capability of the UE to monitor the first power of the first frequency band, a correlation threshold value between the first power of the first frequency band and the second power of the second frequency band, or a set of supported frequency bands associated with measuring the correlation information. As an example, the provision may be performed by one or more of the component 198. FIGS. 5, 6 illustrate an example of the UE 502 performing such functions and/or operations.

The UE 502 may be configured to provide/transmit UL control information 506, which may be inter-band, to the base station 504. In aspects, the UL control information 506 may include a capability of the UE 502 to monitor the first power of the first frequency band (e.g., 610 in FIG. 6), a correlation threshold value (e.g., 614 in FIG. 6) between the first power of the first frequency band (e.g., 610 in FIG. 6) and the second power of a second frequency band (e.g., 608 in FIG. 6), a set of supported frequency bands associated with measuring the correlation information (e.g., 614 in FIG. 6), an indication of hardware at the UE for transmitting the first frequency band (e.g., 610 in FIG. 6) associated with the beam transmissions, a loss parameter of the hardware, a change in the loss parameter of the hardware, and/or the like. Based at least in part on the received UL control information 506, the base station 504 may be configured at 508 to generate an information configuration 510 associated with correlation and/or power information (e.g., 614 in FIG. 6). The base station 504 may be configured to provide the information configuration 510 for reception by the UE 502.

At 804, the UE receives, from the network node, the first frequency band associated with the beam transmissions. As an example, the reception may be performed by one or more of the component 198. FIGS. 5, 6 illustrate an example of the UE 502 performing such functions and/or operations.

In aspects, the UE 502 may be configured to receive, from the base station 504, the first frequency band (e.g., 610 in FIG. 6) associated with the beam transmissions, which may be a continuous beam transmission. In aspects, the first frequency band (e.g., 610 in FIG. 6) may be similar or identical to the second frequency band (e.g., 608 in FIG. 6), while in other aspects, the first frequency band (e.g., 610 in FIG. 6) may be dissimilar or different from the second frequency band (e.g., 608 in FIG. 6).

At 806, the UE determines if the network node has an awareness for the measurement. If the base station or network node (e.g., 502 in FIG. 5; 602 in FIG. 6) is aware, flowchart 800 continues to 808; if not, flowchart 800 continues to 812. As an example, the determination may be performed by one or more of the component 198. FIG. 6 illustrates an example of the base station 504/604 being aware or unaware.

At 808, the UE transmits, for the network node, the first frequency band associated with the beam transmissions. As an example, the transmission may be performed by one or more of the component 198. FIGS. 5, 6 illustrate an example of the UE 502 performing such functions and/or operations.

In aspects for which the base station 504 may be aware of measurements at the UE 502, described herein, the UE 502 may be configured to transmit, for the base station 504, the first frequency band (e.g., 610 as 612 in FIG. 6) associated with the beam transmissions, e.g., reflecting the first frequency beam back to the base station 504. Such transmitting or reflecting may be performed by the UE 502 via a reflector (e.g., 606 in FIG. 6), e.g., when configured with a reconfigurable intelligent surface (RIS), a modulating retro-reflector (MRR), etc.

At 810, the UE provides, for the network node and via the first frequency band, the first power of the first frequency band. As an example, the provision may be performed by one or more of the component 198. FIGS. 5, 6 illustrate an example of the UE 502 performing such functions and/or operations. In some aspects, the UE 502 may be configured to provide, for the base station 504 and via the first frequency band (e.g., 610 in FIG. 6), the first power of the first frequency band (e.g., 610 in FIG. 6) for the information 514.

At 812, the UE receives, from the network node, correlation threshold information associated with the correlation between the first power of the first frequency band and the second power of the second frequency band. As an example, the reception may be performed by one or more of the component 198. FIGS. 5, 6 illustrate an example of the UE 502 performing such functions and/or operations.

The base station 504 may be configured to provide or transmit, for reception by the UE 502, the UL configuration 518, and the UE 502 may be configured, at 520 and via the UL configuration 518, to update an UL output power for the second frequency band (e.g., 608 in FIG. 6) based on at least one of: (1) the correlation between the first power of the first frequency band (e.g., 610 in FIG. 6) and the second power of the second frequency band or (2) the measured first power of the first frequency band (e.g., 610 in FIG. 6). In some aspects, the UE 502 may be configured to update the uplink output power for the second frequency band (e.g., 608 in FIG. 6) based on the correlation (e.g., 614 in FIG. 6) between the first power of the first frequency band (e.g., 610 in FIG. 6) and the second power of the second frequency band (e.g., 608 in FIG. 6) being greater than a power threshold. That is, the UE 502 may be configured, at 520 and via the UL configuration 518, to update an UL output power for the second frequency band (e.g., 608 in FIG. 6) without making direct power measurements therefor, thus improving power efficiency of at least the UE 502 and increasing the overall processing efficiency of the UE 502. In one configuration, the UE 502 may be configured to receive, as provided from the base station 504, correlation threshold information (e.g., 614 in FIG. 6) associated with the correlation between the first power of the first frequency band (e.g., 610 in FIG. 6) and the second power of the second frequency band (e.g., 608 in FIG. 6), based on this correlation threshold information (e.g., 614 in FIG. 6), the UE 502 may be configured to continue or discontinue to monitor the first power of the first frequency band (e.g., 610 in FIG. 6).

At 814, the UE measures at least one of: (1) correlation information associated with a correlation between a first power of a first frequency band and a second power of a second frequency band or (2) the first power of the first frequency band, where the first frequency band and the second frequency band are associated with beam transmissions from a network node, where the first frequency band is associated with a higher periodicity than the second frequency band. As an example, the measurement may be performed by one or more of the component 198. FIGS. 5, 6 illustrate an example of the UE 502 performing such functions and/or operations.

Based at least in part on the information configuration 510, the UE 502 may be configured at 512 to measure at least one of: (1) correlation information associated with a correlation (e.g., 614 in FIG. 6) between a first power of a first frequency band (e.g., 610 in FIG. 6) and a second power of a second frequency band (e.g., 608 in FIG. 6) or (2) the first power of the first frequency band (e.g., 610 in FIG. 6), where the first frequency band (e.g., 610 in FIG. 6) and the second frequency band (e.g., 608 in FIG. 6) are associated with beam transmissions from the base station 504 (e.g., a network node), where the first frequency band (e.g., 610 in FIG. 6) may be associated with a higher periodicity than the second frequency band (e.g., 608 in FIG. 6). For example, the higher periodicity may be associated with data periodicity, a SSB, a slot periodicity, a continues signal, and/or the like for the first frequency band. The UE 502 may then be configured to transmit or provide, for the base station 504, information 514 that may be associated with correlation and/or power information (e.g., 614 in FIG. 6).

At 816, the UE provides, for the network node, at least one of the measured correlation information or the measured first power of the first frequency band for an update of the UL output power for the second frequency band. As an example, the provision may be performed by one or more of the component 198. FIGS. 5, 6 illustrate an example of the UE 502 performing such functions and/or operations.

Subsequent to 814, at 816 the UE 502 may be configured to transmit or provide, for the base station 504, the information 514 that may be associated with correlation and/or power information (e.g., 614 in FIG. 6). The information 514 (e.g., 614 in FIG. 6) may include the measured correlation information and/or the measured first power of the first frequency band (e.g., 610 in FIG. 6) for an update of the uplink output power for the second frequency band (e.g., 608 in FIG. 6), including but not limited to, measured correlation information such as a network correlation value associated with a first correlation information parameter of the base station 504 or a maximal correlation value associated with a second correlation information parameter of the UE 502, where the second correlation information parameter of the UE 502 may be different from the first correlation information parameter of the base station 504, and where the maximal correlation value may be greater than the network correlation value.

At 818, the UE receives, from the network node, a configuration associated with the UL output power for the second frequency band based on at least one of the measured correlation information or the measured first power of the first frequency band. As an example, the reception may be performed by one or more of the component 198. FIGS. 5, 6 illustrate an example of the UE 502 performing such functions and/or operations.

The base station 504, at 516, may be configured to generate a UL configuration 518 associated with the UL output power for the second frequency band (e.g., 608 in FIG. 6) for an update to an UL output power. The UL configuration 518 may be based on and/or associated with the UL output power for the second frequency band (e.g., 608 in FIG. 6) based the information 514 (e.g., 614 in FIG. 6), e.g., based on at least one of the measured correlation information, the measured first power of the first frequency band (e.g., 610 in FIG. 6), and/or the like. The base station 504 may thus be configured to configure the UE with the UL configuration 518 that is associated with the uplink output power for the second frequency band (e.g., 608 in FIG. 6) based on at least one of: (1) the correlation between the first power of the first frequency band (e.g., 610 in FIG. 6) and the second power of the second frequency band (e.g., 608 in FIG. 6) or (2) the measured first power of the first frequency band (e.g., 610 in FIG. 6). In aspects, to generate at 516 the UL configuration 518 as associated with the uplink output power for the second frequency band (e.g., 608 in FIG. 6) for the update to the uplink output power. The base station 504 may be configured to provide or transmit, for reception by the UE 502, the UL configuration 518.

At 820, the UE updates an UL output power for the second frequency band based on at least one of: (1) the correlation between the first power of the first frequency band and the second power of the second frequency band or (2) the measured first power of the first frequency band. As an example, the update may be performed by one or more of the component 198. FIGS. 5, 6 illustrate an example of the UE 502 performing such functions and/or operations.

The UE 502 may be configured, at 520 and via the UL configuration 518, to update an UL output power for the second frequency band (e.g., 608 in FIG. 6) based on at least one of: (1) the correlation between the first power of the first frequency band (e.g., 610 in FIG. 6) and the second power of the second frequency band or (2) the measured first power of the first frequency band (e.g., 610 in FIG. 6). In some aspects, the UE 502 may be configured to update the uplink output power for the second frequency band (e.g., 608 in FIG. 6) based on the correlation (e.g., 614 in FIG. 6) between the first power of the first frequency band (e.g., 610 in FIG. 6) and the second power of the second frequency band (e.g., 608 in FIG. 6) being greater than a power threshold. That is, the UE 502 may be configured, at 520 and via the UL configuration 518, to update an UL output power for the second frequency band (e.g., 608 in FIG. 6) without making direct power measurements therefor, thus improving power efficiency of at least the UE 502 and increasing the overall processing efficiency of the UE 502.

At 822, the UE continues or discontinues to monitor the first power of the first frequency band based on the correlation threshold information. As an example, the continuation or the discontinuation may be performed by one or more of the component 198. FIGS. 5, 6 illustrate an example of the UE 502 performing such functions and/or operations.

In one configuration as noted herein, the UE 502 may be configured to receive, as provided from the base station 504, correlation threshold information (e.g., 614 in FIG. 6) associated with the correlation between the first power of the first frequency band (e.g., 610 in FIG. 6) and the second power of the second frequency band (e.g., 608 in FIG. 6), and based on this correlation threshold information (e.g., 614 in FIG. 6), the UE 502 may be configured to continue or discontinue to monitor the first power of the first frequency band (e.g., 610 in FIG. 6).

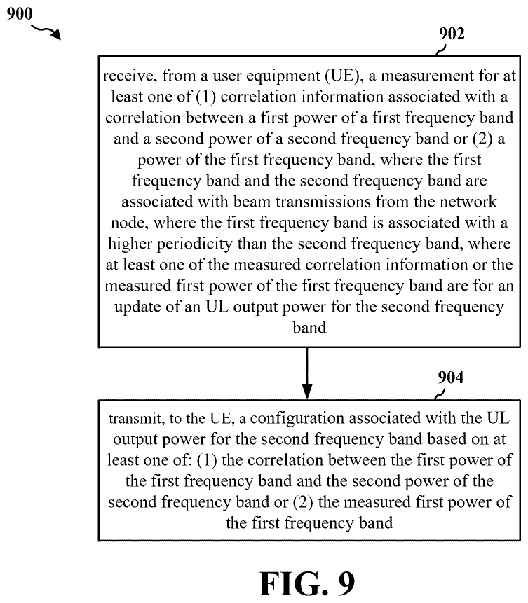

FIG. 9 is a flowchart 900 of a method of wireless communication, in various aspects. The method may be performed by a base station (e.g., the base station 102, 404, 504, 604; the network entity 1202). In some aspects, the method may include aspects described in connection with the communication flow in FIG. 5 and/or aspects described in FIG. 6. The method provides improvements in UE power utilization and control that enables a UE to utilize power correlations for frequency bands to determine the power of other frequency bands without direct power measurements thereof.

At 902, the base station receives, from a UE, a measurement for at least one of (1) correlation information associated with a correlation between a first power of a first frequency band and a second power of a second frequency band or (2) a power of the first frequency band, where the first frequency band and the second frequency band are associated with beam transmissions from the network node, where the first frequency band is associated with a higher periodicity than the second frequency band, where at least one of the measured correlation information or the measured first power of the first frequency band are for an update of an UL output power for the second frequency band. As an example, the reception may be performed by one or more of the component 199. FIGS. 5, 6 illustrate an example of the base station 504 performing such functions/operations.

The UE 502 may be configured to provide/transmit UL control information 506, which may be inter-band, that is received by the base station 504. In aspects, the UL control information 506 may include a capability of the UE 502 to monitor the first power of the first frequency band (e.g., 610 in FIG. 6), a correlation threshold value (e.g., 614 in FIG. 6) between the first power of the first frequency band (e.g., 610 in FIG. 6) and the second power of a second frequency band (e.g., 608 in FIG. 6), a set of supported frequency bands associated with measuring the correlation information (e.g., 614 in FIG. 6), an indication of hardware at the UE for transmitting the first frequency band (e.g., 610 in FIG. 6) associated with the beam transmissions, a loss parameter of the hardware, a change in the loss parameter of the hardware, and/or the like. Based at least in part on the received UL control information 506, the base station 504 may be configured at 508 to generate an information configuration 510 associated with correlation and/or power information (e.g., 614 in FIG. 6). The base station 504 may be configured to provide the information configuration 510 for reception by the UE 502. In aspects, the first frequency band (e.g., 610 in FIG. 6) may be similar or identical to the second frequency band (e.g., 608 in FIG. 6), while in other aspects, the first frequency band (e.g., 610 in FIG. 6) may be dissimilar or different from the second frequency band (e.g., 608 in FIG. 6).

In aspects, the UE 502 may be configured to receive, from the base station 504, the first frequency band (e.g., 610 in FIG. 6) associated with the beam transmissions, which may be a continuous beam transmission. In aspects for which the base station 504 may be aware of measurements at the UE 502, described herein, the UE 502 may be configured to transmit, for the base station 504, the first frequency band (e.g., 610 as 612 in FIG. 6) associated with the beam transmissions, e.g., reflecting the first frequency beam back to the base station 504. Such transmitting or reflecting may be performed by the UE 502 via a reflector (e.g., 606 in FIG. 6), e.g., when configured with a reconfigurable intelligent surface (RIS), a modulating retro-reflector (MRR), etc.

Based at least in part on the information configuration 510, the UE 502 may be configured at 512 to measure at least one of: (1) correlation information associated with a correlation (e.g., 614 in FIG. 6) between a first power of a first frequency band (e.g., 610 in FIG. 6) and a second power of a second frequency band (e.g., 608 in FIG. 6) or (2) the first power of the first frequency band (e.g., 610 in FIG. 6), where the first frequency band (e.g., 610 in FIG. 6) and the second frequency band (e.g., 608 in FIG. 6) are associated with beam transmissions from the base station 504 (e.g., a network node), where the first frequency band (e.g., 610 in FIG. 6) may be associated with a higher periodicity than the second frequency band (e.g., 608 in FIG. 6). For example, the higher periodicity may be associated with data periodicity, a SSB, a slot periodicity, a continues signal, and/or the like for the first frequency band. The UE 502 may then be configured to transmit or provide, for the base station 504, information 514 that may be associated with correlation and/or power information (e.g., 614 in FIG. 6). The information 514 (e.g., 614 in FIG. 6) may include the measured correlation information and/or the measured first power of the first frequency band (e.g., 610 in FIG. 6) for an update of the uplink output power for the second frequency band (e.g., 608 in FIG. 6), including but not limited to, measured correlation information such as a network correlation value associated with a first correlation information parameter of the base station 504 or a maximal correlation value associated with a second correlation information parameter of the UE 502, where the second correlation information parameter of the UE 502 may be different from the first correlation information parameter of the base station 504, and where the maximal correlation value may be greater than the network correlation value. In some aspects, the UE 502 may be configured to provide, for the base station 504 and via the first frequency band (e.g., 610 in FIG. 6), the first power of the first frequency band (e.g., 610 in FIG. 6) for the information 514.

At 904, the base station configures the UE with a configuration associated with the UL output power for the second frequency band based on at least one of: (1) the correlation between the first power of the first frequency band and the second power of the second frequency band or (2) the measured first power of the first frequency band. As an example, the configuration may be performed by one or more of the component 199. FIGS. 5, 6 illustrate an example of the base station 504 performing such functions and/or operations.

The base station 504, at 516, may be configured to generate a UL configuration 518 associated with the UL output power for the second frequency band (e.g., 608 in FIG. 6) for an update to an UL output power. The UL configuration 518 may be based on and/or associated with the UL output power for the second frequency band (e.g., 608 in FIG. 6) based the information 514 (e.g., 614 in FIG. 6), e.g., based on at least one of the measured correlation information, the measured first power of the first frequency band (e.g., 610 in FIG. 6), and/or the like. The base station 504 may thus be configured to configure the UE with the UL configuration 518 that is associated with the uplink output power for the second frequency band (e.g., 608 in FIG. 6) based on at least one of: (1) the correlation between the first power of the first frequency band (e.g., 610 in FIG. 6) and the second power of the second frequency band (e.g., 608 in FIG. 6) or (2) the measured first power of the first frequency band (e.g., 610 in FIG. 6). In aspects, the UL configuration 518 as associated with the UL output power for the second frequency band (e.g., 608 in FIG. 6) for the update to the UL output power.

The base station 504 may be configured to provide or transmit, for reception by the UE 502, the UL configuration 518, and the UE 502 may be configured, at 520 and via the UL configuration 518, to update an UL output power for the second frequency band (e.g., 608 in FIG. 6) based on at least one of: (1) the correlation between the first power of the first frequency band (e.g., 610 in FIG. 6) and the second power of the second frequency band or (2) the measured first power of the first frequency band (e.g., 610 in FIG. 6). In some aspects, the UE 502 may be configured to update the uplink output power for the second frequency band (e.g., 608 in FIG. 6) based on the correlation (e.g., 614 in FIG. 6) between the first power of the first frequency band (e.g., 610 in FIG. 6) and the second power of the second frequency band (e.g., 608 in FIG. 6) being greater than a power threshold. That is, the UE 502 may be configured, at 520 and via the UL configuration 518, to update an UL output power for the second frequency band (e.g., 608 in FIG. 6) without making direct power measurements therefor, thus improving power efficiency of at least the UE 502 and increasing the overall processing efficiency of the UE 502. In one configuration, the UE 502 may be configured to receive, as provided from the base station 504, correlation threshold information (e.g., 614 in FIG. 6) associated with the correlation between the first power of the first frequency band (e.g., 610 in FIG. 6) and the second power of the second frequency band (e.g., 608 in FIG. 6), based on this correlation threshold information (e.g., 614 in FIG. 6), the UE 502 may be configured to continue or discontinue to monitor the first power of the first frequency band (e.g., 610 in FIG. 6).

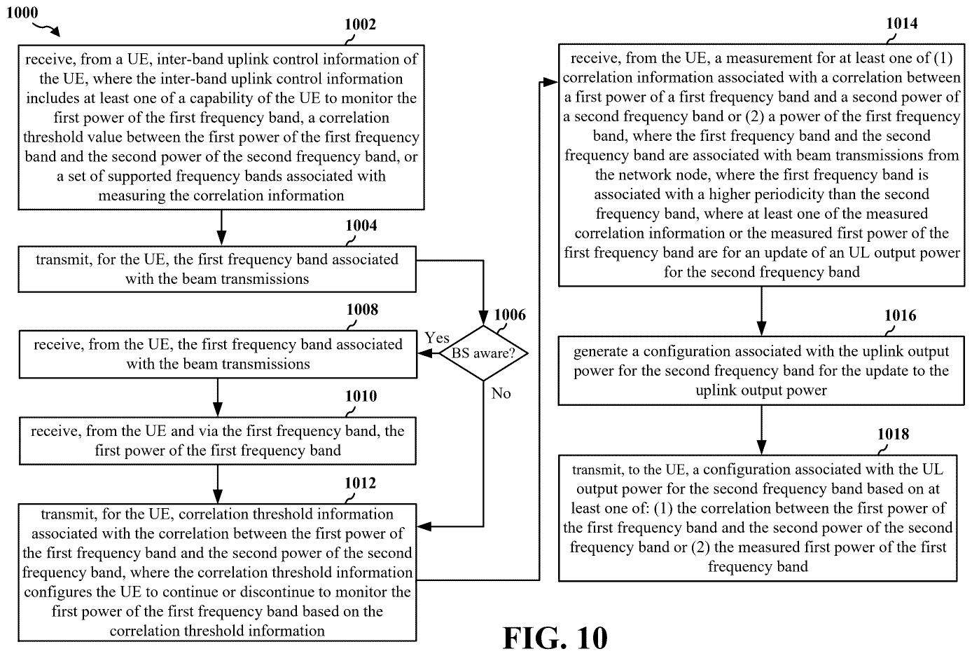

FIG. 10 is a flowchart 1000 of a method of wireless communication, in various aspects. The method may be performed by a base station (e.g., the base station 102, 404, 504, 604; the network entity 1202). In some aspects, the method may include aspects described in connection with the communication flow in FIG. 5 and/or aspects described in FIG. 6. The method provides improvements in UE power utilization and control that enables a UE to utilize power correlations for frequency bands to determine the power of other frequency bands without direct power measurements thereof.

At 1002, the base station receives, from a UE, inter-band UL control information of the UE, where the inter-band uplink control information includes at least one of a capability of the UE to monitor the first power of the first frequency band, a correlation threshold value between the first power of the first frequency band and the second power of the second frequency band, or a set of supported frequency bands associated with measuring the correlation information. As an example, the reception may be performed by one or more of the component 199. FIGS. 5, 6 illustrate an example of the base station 504 performing such functions and/or operations.

The UE 502 may be configured to provide/transmit UL control information 506, which may be inter-band, that is received by the base station 504. In aspects, the UL control information 506 may include a capability of the UE 502 to monitor the first power of the first frequency band (e.g., 610 in FIG. 6), a correlation threshold value (e.g., 614 in FIG. 6) between the first power of the first frequency band (e.g., 610 in FIG. 6) and the second power of a second frequency band (e.g., 608 in FIG. 6), a set of supported frequency bands associated with measuring the correlation information (e.g., 614 in FIG. 6), an indication of hardware at the UE for transmitting the first frequency band (e.g., 610 in FIG. 6) associated with the beam transmissions, a loss parameter of the hardware, a change in the loss parameter of the hardware, and/or the like.

At 1004, the base station transmits, for the UE, the first frequency band associated with the beam transmissions. As an example, the transmission may be performed by one or more of the component 199. FIGS. 5, 6 illustrate an example of the base station 504 performing such functions and/or operations.

In aspects, the UE 502 may be configured to receive, as transmitted or provided from the base station 504, the first frequency band (e.g., 610 in FIG. 6) associated with the beam transmissions, which may be a continuous beam transmission. In aspects, the first frequency band (e.g., 610 in FIG. 6) may be similar or identical to the second frequency band (e.g., 608 in FIG. 6), while in other aspects, the first frequency band (e.g., 610 in FIG. 6) may be dissimilar or different from the second frequency band (e.g., 608 in FIG. 6).

At 1006, the base station determines if it has an awareness for the measurement. If the base station or network node (e.g., 502 in FIG. 5; 602 in FIG. 6) is aware, flowchart 1000 continues to 1008; if not, flowchart 1000 continues to 1012. As an example, the determination may be performed by one or more of the component 199. FIGS. 5, 6 illustrate an example of the base station 504 performing such functions and/or operations.

At 1008, the base station receives, from the UE, the first frequency band associated with the beam transmissions. As an example, the reception may be performed by one or more of the component 199. FIGS. 5, 6 illustrate an example of the base station 504 performing such functions and/or operations.

In aspects for which the base station 504 may be aware of measurements at the UE 502, described herein, the UE 502 may be configured to transmit, as received by the base station 504, the first frequency band (e.g., 610 as 612 in FIG. 6) associated with the beam transmissions, e.g., reflecting the first frequency beam back to the base station 504. Such transmitting or reflecting may be performed by the UE 502 via a reflector (e.g., 606 in FIG. 6), e.g., when configured with a reconfigurable intelligent surface (RIS), a modulating retro-reflector (MRR), etc.

At 1010, the base station receives, from the UE and via the first frequency band, the first power of the first frequency band. As an example, the reception may be performed by one or more of the component 199. FIGS. 5, 6 illustrate an example of the base station 504 performing such functions and/or operations. In some aspects, the UE 502 may be configured to provide, and the base station 504 may be configured to receive, via the first frequency band (e.g., 610 in FIG. 6), the first power of the first frequency band (e.g., 610 in FIG. 6) for the information 514.

At 1012, the base station transmits, for the UE, correlation threshold information associated with the correlation between the first power of the first frequency band and the second power of the second frequency band, where the correlation threshold information configures the UE to continue or discontinue to monitor the first power of the first frequency band based on the correlation threshold information. As an example, the transmission may be performed by one or more of the component 199. FIGS. 5, 6 illustrate an example of the base station 504 performing such functions and/or operations.

The base station 504 may be configured to provide or transmit, for reception by the UE 502, the UL configuration 518, and the UE 502 may be configured, at 520 and via the UL configuration 518, to update an UL output power for the second frequency band (e.g., 608 in FIG. 6) based on at least one of: (1) the correlation between the first power of the first frequency band (e.g., 610 in FIG. 6) and the second power of the second frequency band or (2) the measured first power of the first frequency band (e.g., 610 in FIG. 6). In some aspects, the UE 502 may be configured to update the uplink output power for the second frequency band (e.g., 608 in FIG. 6) based on the correlation (e.g., 614 in FIG. 6) between the first power of the first frequency band (e.g., 610 in FIG. 6) and the second power of the second frequency band (e.g., 608 in FIG. 6) being greater than a power threshold. That is, the UE 502 may be configured, at 520 and via the UL configuration 518, to update an UL output power for the second frequency band (e.g., 608 in FIG. 6) without making direct power measurements therefor, thus improving power efficiency of at least the UE 502 and increasing the overall processing efficiency of the UE 502. In one configuration, the UE 502 may be configured to receive, as provided from the base station 504, correlation threshold information (e.g., 614 in FIG. 6) associated with the correlation between the first power of the first frequency band (e.g., 610 in FIG. 6) and the second power of the second frequency band (e.g., 608 in FIG. 6), based on this correlation threshold information (e.g., 614 in FIG. 6), the UE 502 may be configured to continue or discontinue to monitor the first power of the first frequency band (e.g., 610 in FIG. 6).

At 1014, the base station receives, from the UE, a measurement for at least one of (1) correlation information associated with a correlation between a first power of a first frequency band and a second power of a second frequency band or (2) a power of the first frequency band, where the first frequency band and the second frequency band are associated with beam transmissions from the network node, where the first frequency band is associated with a higher periodicity than the second frequency band, where at least one of the measured correlation information or the measured first power of the first frequency band are for an update of an UL output power for the second frequency band. As an example, the reception may be performed by one or more of the component 199. FIGS. 5, 6 illustrate an example of the base station 504 performing such functions and/or operations.

Based at least in part on the information configuration 510, the UE 502 may be configured at 512 to measure at least one of: (1) correlation information associated with a correlation (e.g., 614 in FIG. 6) between a first power of a first frequency band (e.g., 610 in FIG. 6) and a second power of a second frequency band (e.g., 608 in FIG. 6) or (2) the first power of the first frequency band (e.g., 610 in FIG. 6), where the first frequency band (e.g., 610 in FIG. 6) and the second frequency band (e.g., 608 in FIG. 6) are associated with beam transmissions from the base station 504 (e.g., a network node), where the first frequency band (e.g., 610 in FIG. 6) may be associated with a higher periodicity than the second frequency band (e.g., 608 in FIG. 6). For example, the higher periodicity may be associated with data periodicity, a SSB, a slot periodicity, a continues signal, and/or the like for the first frequency band. The UE 502 may then be configured to transmit or provide, and the base station 504 be configured to receive, information 514 that may be associated with correlation and/or power information (e.g., 614 in FIG. 6). The UE 502 may be configured to transmit or provide, for the base station 504, the information 514 that may be associated with correlation and/or power information (e.g., 614 in FIG. 6). The information 514 (e.g., 614 in FIG. 6) may include the measured correlation information and/or the measured first power of the first frequency band (e.g., 610 in FIG. 6) for an update of the uplink output power for the second frequency band (e.g., 608 in FIG. 6), including but not limited to, measured correlation information such as a network correlation value associated with a first correlation information parameter of the base station 504 or a maximal correlation value associated with a second correlation information parameter of the UE 502, where the second correlation information parameter of the UE 502 may be different from the first correlation information parameter of the base station 504, and where the maximal correlation value may be greater than the network correlation value.

At 1016, the base station generates a configuration associated with the UL output power for the second frequency band for the update to the uplink output power. As an example, the generation may be performed by one or more of the component 199. FIGS. 5, 6 illustrate an example of the base station 504 performing such functions and/or operations.

The base station 504, at 516, may be configured to generate a UL configuration 518 associated with the UL output power for the second frequency band (e.g., 608 in FIG. 6) for an update to an UL output power. The UL configuration 518 may be based on and/or associated with the UL output power for the second frequency band (e.g., 608 in FIG. 6) based the information 514 (e.g., 614 in FIG. 6), e.g., based on at least one of the measured correlation information, the measured first power of the first frequency band (e.g., 610 in FIG. 6), and/or the like. The base station 504 may thus be configured to configure the UE with the UL configuration 518 that is associated with the UL output power for the second frequency band (e.g., 608 in FIG. 6) based on at least one of: (1) the correlation between the first power of the first frequency band (e.g., 610 in FIG. 6) and the second power of the second frequency band (e.g., 608 in FIG. 6) or (2) the measured first power of the first frequency band (e.g., 610 in FIG. 6). In aspects, the UL configuration 518 as associated with the UL output power for the second frequency band (e.g., 608 in FIG. 6) for the update to the UL output power.

At 1018, the base station configures the UE with a configuration associated with the UL output power for the second frequency band based on at least one of: (1) the correlation between the first power of the first frequency band and the second power of the second frequency band or (2) the measured first power of the first frequency band. As an example, the configuration may be performed by one or more of the component 199. FIGS. 5, 6 illustrate an example of the base station 504 performing such functions and/or operations.

The base station 504 may be configured to provide or transmit, for reception by the UE 502, the UL configuration 518, and the UE 502 may be configured, at 520 and via the UL configuration 518, to update an UL output power for the second frequency band (e.g., 608 in FIG. 6) based on at least one of: (1) the correlation between the first power of the first frequency band (e.g., 610 in FIG. 6) and the second power of the second frequency band or (2) the measured first power of the first frequency band (e.g., 610 in FIG. 6). In some aspects, the UE 502 may be configured to update the uplink output power for the second frequency band (e.g., 608 in FIG. 6) based on the correlation (e.g., 614 in FIG. 6) between the first power of the first frequency band (e.g., 610 in FIG. 6) and the second power of the second frequency band (e.g., 608 in FIG. 6) being greater than a power threshold. That is, the UE 502 may be configured, at 520 and via the UL configuration 518, to update an UL output power for the second frequency band (e.g., 608 in FIG. 6) without making direct power measurements therefor, thus improving power efficiency of at least the UE 502 and increasing the overall processing efficiency of the UE 502. In one configuration, the UE 502 may be configured to receive, as provided from the base station 504, correlation threshold information (e.g., 614 in FIG. 6) associated with the correlation between the first power of the first frequency band (e.g., 610 in FIG. 6) and the second power of the second frequency band (e.g., 608 in FIG. 6), based on this correlation threshold information (e.g., 614 in FIG. 6), the UE 502 may be configured to continue or discontinue to monitor the first power of the first frequency band (e.g., 610 in FIG. 6).

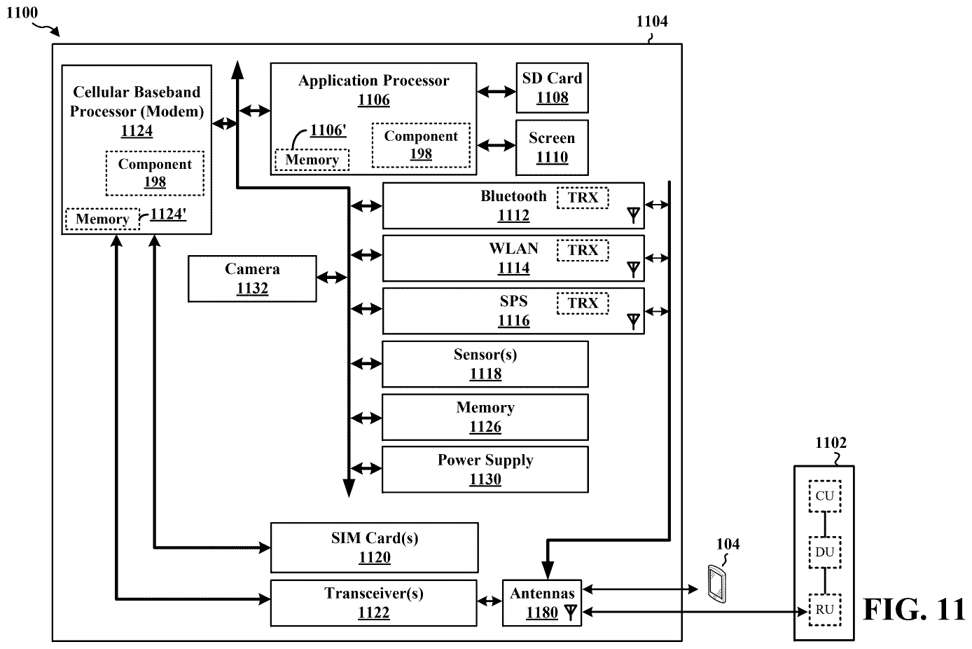

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see UE 350 of FIG. 3) and include the additional modules of the apparatus 1104.

As discussed supra, the component 198 may be configured to configured to measure at least one of: (1) correlation information associated with a correlation between a first power of a first frequency band and a second power of a second frequency band or (2) the first power of the first frequency band, where the first frequency band and the second frequency band are associated with beam transmissions from a network node, where the first frequency band is associated with a higher periodicity than the second frequency band. The component 198 may be further configured to update an uplink output power for the second frequency band based on at least one of: (1) the correlation between the first power of the first frequency band and the second power of the second frequency band or (2) the measured first power of the first frequency band. The component 198 may be configured to provide, for the network node, at least one of the measured correlation information or the measured first power of the first frequency band for an update of the uplink output power for the second frequency band, and to receive, from the network node, a configuration associated with the uplink output power for the second frequency band based on at least one of the measured correlation information or the measured first power of the first frequency band. The component 198 may be configured to provide, for the network node, inter-band uplink control information of the UE, where the inter-band uplink control information includes at least one of a capability of the UE to monitor the first power of the first frequency band, a correlation threshold value between the first power of the first frequency band and the second power of the second frequency band, or a set of supported frequency bands associated with measuring the correlation information. The component 198 may be configured to receive, from the network node, the first frequency band associated with the beam transmissions, and to transmit, for the network node, the first frequency band associated with the beam transmissions. The component 198 may be configured to provide, for the network node and via the first frequency band, the first power of the first frequency band. The component 198 may be configured to receive, from the network node, correlation threshold information associated with the correlation between the first power of the first frequency band and the second power of the second frequency band, and to continue or discontinue to monitor the first power of the first frequency band based on the correlation threshold information. The component 198 may be further configured to perform any of the aspects described in connection with the flowchart in any of FIGS. 7-10, and/or any of the aspects performed by the UE in any of FIGS. 4, 5, 6. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, may include means for measuring at least one of: (1) correlation information associated with a correlation between a first power of a first frequency band and a second power of a second frequency band or (2) the first power of the first frequency band, where the first frequency band and the second frequency band are associated with beam transmissions from a network node, where the first frequency band is associated with a higher periodicity than the second frequency band. In the configuration, the apparatus 1104, and in particular the cellular baseband processor 1124 and/or the application processor 1106, may include means for updating an uplink output power for the second frequency band based on at least one of: (1) the correlation between the first power of the first frequency band and the second power of the second frequency band or (2) the measured first power of the first frequency band. In one configuration, the apparatus 1104, and in particular the cellular baseband processor 1124 and/or the application processor 1106, may include means for providing, for the network node, at least one of the measured correlation information or the measured first power of the first frequency band for an update of the uplink output power for the second frequency band, and for receiving, from the network node, a configuration associated with the uplink output power for the second frequency band based on at least one of the measured correlation information or the measured first power of the first frequency band. In one configuration, the apparatus 1104, and in particular the cellular baseband processor 1124 and/or the application processor 1106, may include means for providing, for the network node, inter-band uplink control information of the UE, where the inter-band uplink control information includes at least one of a capability of the UE to monitor the first power of the first frequency band, a correlation threshold value between the first power of the first frequency band and the second power of the second frequency band, or a set of supported frequency bands associated with measuring the correlation information. In one configuration, the apparatus 1104, and in particular the cellular baseband processor 1124 and/or the application processor 1106, may include means for receiving, from the network node, the first frequency band associated with the beam transmissions, and for transmitting, for the network node, the first frequency band associated with the beam transmissions. In one configuration, the apparatus 1104, and in particular the cellular baseband processor 1124 and/or the application processor 1106, may include means for providing, for the network node and via the first frequency band, the first power of the first frequency band. In one configuration, the apparatus 1104, and in particular the cellular baseband processor 1124 and/or the application processor 1106, may include means for receiving, from the network node, correlation threshold information associated with the correlation between the first power of the first frequency band and the second power of the second frequency band, and for continuing or discontinuing monitoring the first power of the first frequency band based on the correlation threshold information.

The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

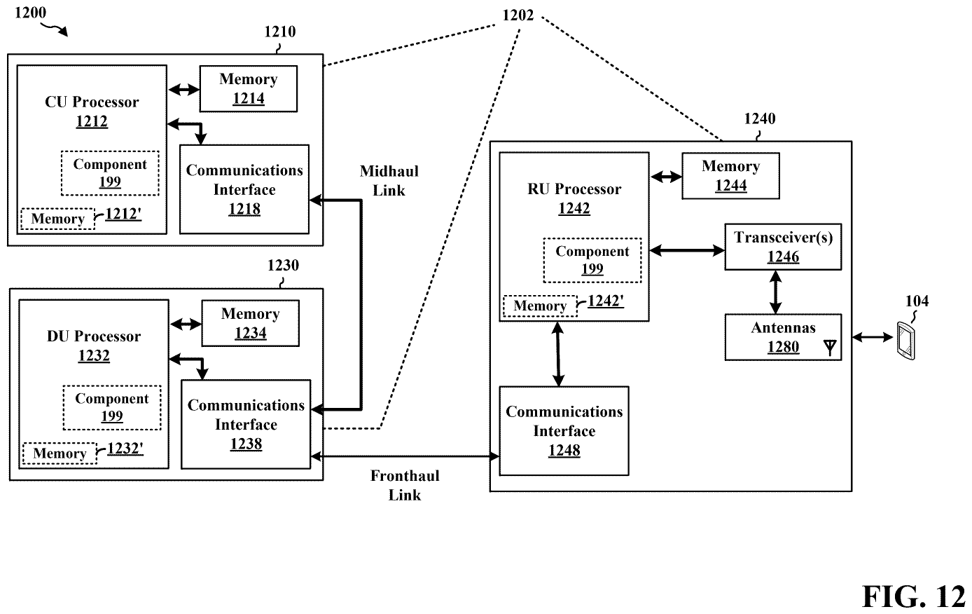

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include a CU processor 1212. The CU processor 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include additional memory modules 1234 and a communications interface 1238. The DU 1230 communicates with the RU 1240 through a fronthaul link. The RU 1240 may include an RU processor 1242. The RU processor 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive, from a user equipment (UE), a measurement for at least one of (1) correlation information associated with a correlation between a first power of a first frequency band and a second power of a second frequency band or (2) a power of the first frequency band, where the first frequency band and the second frequency band are associated with beam transmissions from the network node, where the first frequency band is associated with a higher periodicity than the second frequency band, where at least one of the measured correlation information or the measured first power of the first frequency band are for an update of an uplink output power for the second frequency band. The component 199 may be further configured to transmit, to the UE, a configuration associated with the uplink output power for the second frequency band based on at least one of: (1) the correlation between the first power of the first frequency band and the second power of the second frequency band or (2) the measured first power of the first frequency band. The component 199 may be configured to generate the configuration associated with the uplink output power for the second frequency band for the update to the uplink output power. The component 199 may be configured to receive, from the UE, inter-band uplink control information of the UE, where the inter-band uplink control information includes at least one of a capability of the UE to monitor the first power of the first frequency band, a correlation threshold value between the first power of the first frequency band and the second power of the second frequency band, or a set of supported frequency bands associated with measuring the correlation information. The component 199 may be configured to transmit, for the UE, the first frequency band associated with the beam transmissions, and to receive, from the UE, the first frequency band associated with the beam transmissions. The component 199 may be configured to receive, from the UE and via the first frequency band, the first power of the first frequency band. The component 199 may be configured to transmit, for the UE, correlation threshold information associated with the correlation between the first power of the first frequency band and the second power of the second frequency band, where the correlation threshold information configures the UE to continue or discontinue to monitor the first power of the first frequency band based on the correlation threshold information. That is, aspects provide inter-band power correlation reporting for continuous UE UL power control that enables a UE to utilize power correlations for frequency bands to determine the power of other frequency bands without direct power measurements thereof, which reduces power consumption. The component 199 may be further configured to perform any of the aspects described in connection with the flowchart in any of FIGS. 7-10, and/or any of the aspects performed by the UE in any of FIGS. 4, 5, 6. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202 may include means for receiving, from a user equipment (UE), a measurement for at least one of (1) correlation information associated with a correlation between a first power of a first frequency band and a second power of a second frequency band or (2) a power of the first frequency band, where the first frequency band and the second frequency band are associated with beam transmissions from the network node, where the first frequency band is associated with a higher periodicity than the second frequency band, where at least one of the measured correlation information or the measured first power of the first frequency band are for an update of an uplink output power for the second frequency band. In the configuration, the network entity 1202 may include means for transmitting, to the UE, a configuration associated with the uplink output power for the second frequency band based on at least one of: (1) the correlation between the first power of the first frequency band and the second power of the second frequency band or (2) the measured first power of the first frequency band. In one configuration, the network entity 1202 may include means for generating the configuration associated with the uplink output power for the second frequency band for the update to the uplink output power. In one configuration, the network entity 1202 may include means for receiving, from the UE, inter-band uplink control information of the UE, where the inter-band uplink control information includes at least one of a capability of the UE to monitor the first power of the first frequency band, a correlation threshold value between the first power of the first frequency band and the second power of the second frequency band, or a set of supported frequency bands associated with measuring the correlation information. In one configuration, the network entity 1202 may include means for transmitting, for the UE, the first frequency band associated with the beam transmissions and for receiving, from the UE, the first frequency band associated with the beam transmissions. In one configuration, the network entity 1202 may include means for receiving, from the UE and via the first frequency band, the first power of the first frequency band. In one configuration, the network entity 1202 may include means for transmitting, for the UE, correlation threshold information associated with the correlation between the first power of the first frequency band and the second power of the second frequency band, where the correlation threshold information configures the UE to continue or discontinue to monitor the first power of the first frequency band based on the correlation threshold information. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

Wireless communication networks, such as an LTE network and/or a 5G NR network, may be designed for UE and base station power efficiency. Future wireless communication networks beyond 5G NR, such as 5G+ and 6G, may increase the use of additional frequencies for communications and additional types of communications, which have corresponding impacts on power consumption for UEs and/or base stations. That is, increased communications and higher-power consumption for additional supported communication frequencies may increase power consumption for devices associated with a wireless communication network.

As one example, a power amplifier (PA) used for UL transmissions in a wireless communication network may have a dominant part in overall modem power consumption, which may be exacerbated in new/additional frequency bands with higher carrier frequencies that may decrease the PA output power and reduce the power-added efficiency (PAE). Determining an optimal PA output power for power efficiency (e.g., bits per Joule) may be complex and difficult, and may involve a continuous tracking of the channel(s) and/or blockers, which may involve additional power consumption. Further, this continuous tracking may not be feasible in all bands as some of the bands may have a high multi-user occupancy (e.g., in frequency range designation FR1 (410 MHz-7.125 GHz) bands).

Various aspects relate generally to wireless communications systems and user equipment power control. Some aspects more specifically relate to reporting inter-band power correlation(s) for continuous UE UL power control. In some examples, a continuous UL power procedure is provided according to a report of new power correlation band information. For instance, a UE may change its UL output power in a first band according to the power measurements in second band, where this second band may have a high power correlation with the first band, e.g., as measured by the UE, and may also be more available/accessible for the power measurements.

Particular aspects of the subject matter described in this disclosure can be implemented to realize one or more of the following potential advantages. In some examples, by utilizing the power correlation between frequencies, the described techniques can be used to maintain continuous UL power control for efficient UE power control that obviates monitoring power for each controlled frequency. That is, in aspects, unoccupied frequency bands may be utilized for power measurements which may then be used to extrapolate/determine power measurements for occupied frequency bands. This reduces power consumption by determining power measurements for frequencies without direct measurements and makes network-associated devices more power efficient.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, the method including: measuring at least one of: (1) correlation information associated with a correlation between a first power of a first frequency band and a second power of a second frequency band or (2) the first power of the first frequency band, where the first frequency band and the second frequency band are associated with beam transmissions from a network node, where the first frequency band is associated with a higher periodicity than the second frequency band; and updating an uplink output power for the second frequency band based on at least one of: (1) the correlation between the first power of the first frequency band and the second power of the second frequency band or (2) the measured first power of the first frequency band.

Aspect 2 is the method of aspect 1, further including: providing, for the network node, at least one of the measured correlation information or the measured first power of the first frequency band for an update of the uplink output power for the second frequency band; and receiving, from the network node, a configuration associated with the uplink output power for the second frequency band based on at least one of the measured correlation information or the measured first power of the first frequency band.

Aspect 3 is the method of aspect 2, where the measured correlation information includes at least one of a network correlation value associated with a first correlation information parameter of the network node or a maximal correlation value associated with a second correlation information parameter of the UE, where the second correlation information parameter of the UE is different from the first correlation information parameter of the network node, and where the maximal correlation value is greater than the network correlation value.

Aspect 4 is the method of any of aspects 1 to 3, where the first frequency band is identical to the second frequency band.

Aspect 5 is the method of any of aspects 1 to 3, where the first frequency band is different from the second frequency band.

Aspect 6 is the method of any of aspects 1 to 5, where updating the uplink output power for the second frequency band based on the correlation between the first power of the first frequency band and the second power of the second frequency band includes: updating the uplink output power for the second frequency band based on the correlation between the first power of the first frequency band and the second power of the second frequency band being greater than a power threshold.

Aspect 7 is the method of any of aspects 1 to 6, further including: providing, for the network node, inter-band uplink control information of the UE, where the inter-band uplink control information includes at least one of a capability of the UE to monitor the first power of the first frequency band, a correlation threshold value between the first power of the first frequency band and the second power of the second frequency band, or a set of supported frequency bands associated with measuring the correlation information.

Aspect 8 is the method of aspect 7, further including: receiving, from the network node, the first frequency band associated with the beam transmissions; and transmitting, for the network node, the first frequency band associated with the beam transmissions.

Aspect 9 is the method of aspect 7, where the inter-band uplink control information further includes at least one of an indication of hardware at the UE for transmitting the first frequency band associated with the beam transmissions, a loss parameter of the hardware, or a change in the loss parameter of the hardware.

Aspect 10 is the method of any of aspects 1 to 9, where measuring the correlation between the first power of the first frequency band and the second power of the second frequency band includes measuring the correlation between the first power of the first frequency band and the second power of the second frequency band based on a correlation information parameter that is associated with the measured correlation information, where the correlation information parameter indicates a linear correlation or a non-linear correlation.

Aspect 11 is the method of aspect 10, where measuring the power of the first frequency band includes monitoring the first power of the first frequency band for a change to the first power of the first frequency band; where updating the uplink output power for the second frequency band includes updating the uplink output power for the second frequency band based on the correlation information parameter and the change to the first power of the first frequency band.

Aspect 12 is the method of aspect 11, where the change to the first power of the first frequency band is at least one of a minimum change to the first power of the first frequency band or is associated with a continuous power threshold value.

Aspect 13 is the method of aspect 11, further including: providing, for the network node and via the first frequency band, the first power of the first frequency band.

Aspect 14 is the method of aspect 11, further including: receiving, from the network node via at least one transceiver of the UE, correlation threshold information associated with the correlation between the first power of the first frequency band and the second power of the second frequency band; and continuing or discontinuing monitoring the first power of the first frequency band based on the correlation threshold information.

Aspect 15 is a method of wireless communication at a network node, including: receiving, from a user equipment (UE), a measurement for at least one of (1) correlation information associated with a correlation between a first power of a first frequency band and a second power of a second frequency band or (2) a power of the first frequency band, where the first frequency band and the second frequency band are associated with beam transmissions from the network node, where the first frequency band is associated with a higher periodicity than the second frequency band, where at least one of the measured correlation information or the measured first power of the first frequency band are for an update of an uplink output power for the second frequency band; and transmitting, to the UE, a configuration associated with the uplink output power for the second frequency band based on at least one of: (1) the correlation between the first power of the first frequency band and the second power of the second frequency band or (2) the measured first power of the first frequency band.

Aspect 16 is the method of aspect 15, further including: generating the configuration associated with the uplink output power for the second frequency band for the update to the uplink output power.

Aspect 17 is the method of aspect 16, where the measured correlation information includes at least one of a network correlation value associated with a first correlation information parameter of the network node or a maximal correlation value associated with a second correlation information parameter of the UE, where the second correlation information parameter of the UE is different from the first correlation information parameter of the network node, and where the maximal correlation value is greater than the network correlation value.

Aspect 18 is the method of any of aspects 15 to 17, where the first frequency band is identical to the second frequency band.

Aspect 19 is the method of any of aspects 15 to 17, where the first frequency band is different from the second frequency band.

Aspect 20 is the method of any of aspects 15 to 19, where the configuration associated with the uplink output power for the second frequency band indicates to update the uplink output power for the second frequency band based on the correlation between the first power of the first frequency band and the second power of the second frequency band being greater than a power threshold.

Aspect 21 is the method of any of aspects 15 to 20, further including: receiving, from the UE, inter-band uplink control information of the UE, where the inter-band uplink control information includes at least one of a capability of the UE to monitor the first power of the first frequency band, a correlation threshold value between the first power of the first frequency band and the second power of the second frequency band, or a set of supported frequency bands associated with measuring the correlation information.

Aspect 22 is the method of aspect 21, where the network node has an awareness of the measurement, further including: transmitting, for the UE, the first frequency band associated with the beam transmissions; and receiving, from the UE, the first frequency band associated with the beam transmissions.

Aspect 23 is the method of aspect 21, where the network node has an awareness of the measurement, where the inter-band uplink control information further includes at least one of an indication of hardware at the UE for transmitting the first frequency band associated with the beam transmissions, a loss parameter of the hardware, or a change in the loss parameter of the hardware.

Aspect 24 is the method of any of aspects 15 to 23, where the measurement of the correlation between the first power of the first frequency band and the second power of the second frequency band indicates the correlation between the first power of the first frequency band and the second power of the second frequency band based on a correlation information parameter that is associated with the measured correlation information, where the correlation information parameter indicates a linear correlation or a non-linear correlation.

Aspect 25 is the method of aspect 24, where the measurement includes a change to the first power of the first frequency band associated with a monitoring of the first power of the first frequency band; where the configuration associated with the uplink output power for the second frequency band indicates to update the uplink output power for the second frequency band based on the correlation information parameter and the change to the first power of the first frequency band.

Aspect 26 is the method of aspect 25, where the change to the first power of the first frequency band is at least one of a minimum change to the first power of the first frequency band or is associated with a continuous power threshold value.

Aspect 27 is the method of aspect 25, further including: receiving, from the UE and via the first frequency band, the first power of the first frequency band.

Aspect 28 is the method of aspect 25, further including: transmitting, for the UE via at least one transceiver of the network node, correlation threshold information associated with the correlation between the first power of the first frequency band and the second power of the second frequency band, where the correlation threshold information configures the UE to continue or discontinue to monitor the first power of the first frequency band based on the correlation threshold information.

Aspect 29 is an apparatus for wireless communication including means for implementing any of aspects 1 to 15.

Aspect 30 is a computer-readable medium (e.g., a non-transitory computer-readable medium) storing computer executable code, the code when executed by at least one processor causes the at least one processor to implement any of aspects 1 to 15.

Aspect 31 is an apparatus for wireless communication at a network node. The apparatus includes a memory; and at least one processor coupled to the memory and, based at least in part on information stored in the memory, the at least one processor is configured to implement any of aspects 1 to 15.

Aspect 32 is the apparatus of aspect 31, further including at least one of a transceiver or an antenna coupled to the at least one processor.

Aspect 33 is an apparatus for wireless communication including means for implementing any of aspects 16 to 28.

Aspect 34 is a computer-readable medium (e.g., a non-transitory computer-readable medium) storing computer executable code, the code when executed by at least one processor causes the at least one processor to implement any of aspects 16 to 28.

Aspect 35 is an apparatus for wireless communication at a network node. The apparatus includes a memory; and at least one processor coupled to the memory and, based at least in part on information stored in the memory, the at least one processor is configured to implement any of aspects 16 to 28.

Aspect 36 is the apparatus of aspect 35, further including at least one of a transceiver or an antenna coupled to the at least one processor.

1. An apparatus for wireless communication at a user equipment (UE), comprising: a memory; and
at least one processor coupled to the memory and, based at least in part on information stored in the memory, the at least one processor is configured to:
measure at least one of (1) correlation information associated with a correlation between a first power of a first frequency band and a second power of a second frequency band or (2) the first power of the first frequency band, wherein the first frequency band and the second frequency band are associated with beam transmissions from a network node, wherein the first frequency band is associated with a higher periodicity than the second frequency band; and update an uplink output power for the second frequency band based on at least one of: (1) the correlation between the first power of the first frequency band and the second power of the second frequency band or (2) the measured first power of the first frequency band.

2. The apparatus of claim 1, wherein the at least one processor is further configured to:
provide, for the network node, at least one of the measured correlation information or the measured first power of the first frequency band for an update of the uplink output power for the second frequency band; and
receive, from the network node, a configuration associated with the uplink output power for the second frequency band based on at least one of the measured correlation information or the measured first power of the first frequency band.

3. The apparatus of claim 2, wherein the measured correlation information includes at least one of a network correlation value associated with a first correlation information parameter of the network node or a maximal correlation value associated with a second correlation information parameter of the UE, wherein the second correlation information parameter of the UE is different from the first correlation information parameter of the network node, and wherein the maximal correlation value is greater than the network correlation value.

4. The apparatus of claim 1, wherein the first frequency band is identical to the second frequency band.

5. The apparatus of claim 1, wherein the first frequency band is different from the second frequency band.

6. The apparatus of claim 1, wherein to update the uplink output power for the second frequency band based on the correlation between the first power of the first frequency band and the second power of the second frequency band, the at least one processor is configured to update the uplink output power for the second frequency band based on the correlation between the first power of the first frequency band and the second power of the second frequency band being greater than a power threshold.

7. The apparatus of claim 1, wherein the at least one processor is further configured to:
provide, for the network node, inter-band uplink control information of the UE, wherein the inter-band uplink control information includes at least one of a capability of the UE to monitor the first power of the first frequency band, a correlation threshold value between the first power of the first frequency band and the second power of the second frequency band, or a set of supported frequency bands associated with measuring the correlation information.

8. The apparatus of claim 7, wherein the at least one processor is further configured to:
receive, from the network node, the first frequency band associated with the beam transmissions; and
transmit, for the network node, the first frequency band associated with the beam transmissions.

9. The apparatus of claim 7, wherein the inter-band uplink control information further includes at least one of an indication of hardware at the UE for transmitting the first frequency band associated with the beam transmissions, a loss parameter of the hardware, or a change in the loss parameter of the hardware.

10. The apparatus of claim 1, wherein to measure the correlation between the first power of the first frequency band and the second power of the second frequency band, the at least one processor is configured to measure the correlation between the first power of the first frequency band and the second power of the second frequency band based on a correlation information parameter that is associated with the measured correlation information, wherein the correlation information parameter indicates a linear correlation or a non-linear correlation.

11. The apparatus of claim 10, wherein to measure the first power of the first frequency band, the at least one processor is configured to monitor the first power of the first frequency band for a change to the first power of the first frequency band;
wherein to update the uplink output power for the second frequency band, the at least one processor is configured to update the uplink output power for the second frequency band based on the correlation information parameter and the change to the first power of the first frequency band.

12. The apparatus of claim 11, wherein the change to the first power of the first frequency band is at least one of a minimum change to the first power of the first frequency band or is associated with a continuous power threshold value.

13. The apparatus of claim 11, wherein the at least one processor is further configured to:
provide, for the network node and via the first frequency band, the first power of the first frequency band.

14. The apparatus of claim 11, wherein the at least one processor is further configured to:
receive, from the network node, correlation threshold information associated with the correlation between the first power of the first frequency band and the second power of the second frequency band; and
continue or discontinue to monitor the first power of the first frequency band based on the correlation threshold information.

15. An apparatus for wireless communication at a network node, comprising:
a memory; and
at least one processor coupled to the memory and, based at least in part on information stored in the memory, the at least one processor is configured to:
receive, from a user equipment (UE), a measurement for at least one of (1) correlation information associated with a correlation between a first power of a first frequency band and a second power of a second frequency band or (2) a power of the first frequency band, wherein the first frequency band and the second frequency band are associated with beam transmissions from the network node, wherein the first frequency band is associated with a higher periodicity than the second frequency band, wherein at least one of the measured correlation information or the measured first power of the first frequency band are for an update of an uplink output power for the second frequency band; and transmit, to the UE, a configuration associated with the uplink output power for the second frequency band based on at least one of: (1) the correlation between the first power of the first frequency band and the second power of the second frequency band or (2) the measured first power of the first frequency band.

16. The apparatus of claim 15, wherein the at least one processor is further configured to:
generate the configuration associated with the uplink output power for the second frequency band for the update to the uplink output power.

17. The apparatus of claim 16, wherein the measured correlation information includes at least one of a network correlation value associated with a first correlation information parameter of the network node or a maximal correlation value associated with a second correlation information parameter of the UE, wherein the second correlation information parameter of the UE is different from the first correlation information parameter of the network node, and wherein the maximal correlation value is greater than the network correlation value.

18. The apparatus of claim 15, wherein the first frequency band is identical to the second frequency band.

19. The apparatus of claim 15, wherein the first frequency band is different from the second frequency band.

20-28. (canceled)

29. A method of wireless communication at a user equipment (UE), comprising:
measuring at least one of: (1) correlation information associated with a correlation between a first power of a first frequency band and a second power of a second frequency band or (2) the first power of the first frequency band, wherein the first frequency band and the second frequency band are associated with beam transmissions from a network node, wherein the first frequency band is associated with a higher periodicity than the second frequency band; and
updating an uplink output power for the second frequency band based on at least one of: (1) the correlation between the first power of the first frequency band and the second power of the second frequency band or (2) the measured first power of the first frequency band.

30. (canceled)
